(19) United States
(12) Patent Application Publication
(10) Pub. No.: US 2019/0204961 A1
(43) Pub. Date: Jul. 4, 2019

(54) TOUCH STRUCTURE AND CONTROL METHOD THEREOF, DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Hanyan SUN, Beijing (CN); In Ho PARK, Beijing (CN); Weitao CHEN, Beijing (CN)

(21) Appl. No.: 15/993,776

(22) Filed: May 31, 2018

(30) Foreign Application Priority Data
Jan. 2, 2018 (CN) 201810002652.7

(51) Int. Cl. G06F 3/046; G06F 3/041; G06F 3/0354; G02B 5/20

(52) U.S. Cl. CPC G06F 3/046; G06F 3/0412; G06F 2203/04104; G06F 3/03545; G02B 5/201; G06F 3/0416

(57) ABSTRACT

A touch structure and a control method thereof, and a display device are provided. The touch structure includes a first electromagnetic induction unit; second electromagnetic induction units arranged in an array which can cooperate with the first electromagnetic induction unit to generate electrical signals by electromagnetic induction; a signal collecting unit configured to collect electrical signals generated by electromagnetic induction between the second electromagnetic induction units and the first electromagnetic induction unit.

### CROSS REFERENCE TO RELATED APPLICATIONS

The present application claims the priority of the Chinese Patent Application No. 201810002652.7 filed in SIPO and entitled “Touch Structure and Control Method Thereof, Display Device” filed on Jan. 2, 2018, which is incorporated herein by reference in its entirety.

### TECHNICAL FIELD

Embodiments of the present disclosure relate to a touch structure and a control method thereof, and a display device.

### BACKGROUND

Touch technology is a technology for implementing controlling operation through touching. With the rapid development of science and technology, touch technology has been widely applied in various electronic devices and various fields.

There are mainly several kinds of touch technologies, such as resistive type, capacitive type, surface acoustic wave type, infrared light induction type, in which resistive and capacitive touch screens are primarily applied in electronic products.

### SUMMARY

Embodiments of the present disclosure provide a touch structure and a control method thereof, and a display device.

At least one embodiment of the present disclosure provides a touch structure, comprising: a first electromagnetic induction unit; second electromagnetic induction units arranged in array, the second electromagnetic induction units being configured to generate electrical signals by electromagnetic inducting with the first electromagnetic induction unit; and a signal collecting unit configured to collect electrical signals generated by electromagnetic induction between the second electromagnetic induction units and the first electromagnetic induction unit.

For example, each of the second electromagnetic induction unit comprises a metal coil and the first electromagnetic induction unit comprises a magnet.

For example, the second electromagnetic induction unit comprises a metal coil and the first electromagnetic induction unit comprises a metal.

For example, the metal coil is a square coil.

For example, the metal coil is a square coil.

For example, the touch structure further comprises a first substrate and a second substrate; the second electromagnetic induction units arranged in array being sandwiched between the first substrate and the second substrate.

For example, the touch structure further comprises a stylus, wherein the first electromagnetic induction unit is disposed at an end of the stylus and the stylus includes a body made of insulating material.

For example, in the second electromagnetic induction units arranged in array, the metal coils in a same lateral row are connected to a same routing at one end, and the metal coils in a same vertical row are connected to a same routing at another end.

For example, in the second electromagnetic induction units arranged in array, the metal coils in a same lateral row are connected to a same routing at one end, and the metal coils in a same vertical row are connected to a same routing at another end.

For example, in the second electromagnetic induction units arranged in array, each of the second electromagnetic induction units includes a separate routing, to allow electrical signals generated by each of the second electromagnetic induction units to be detected separately, and to implement multi-touch.

For example, in the second electromagnetic induction units arranged in array, each of the second electromagnetic induction units includes a separate routing, to allow electrical signals generated by each of the second electromagnetic induction units to be detected separately, and to implement multi-touch.

For example, the routings of the second electromagnetic induction units are arranged in parallel, and an insulating layer is disposed between any two routings.

At least one embodiment of the present disclosure provides a control method for the touch structure, comprising: collecting electrical signals generated by electromagnetic induction between the second electromagnetic induction units and the first electromagnetic induction unit; determining which one of the second electromagnetic induction units generates the electromagnetic induction according to the electrical signals; and determining a position of the one second electromagnetic induction unit generating the electromagnetic induction as a touch point.

For example, when the first electromagnetic induction unit is a magnet and the second electromagnetic induction units comprise metal coils, the method further comprises: energizing the metal coils.

For example, when the first electromagnetic induction unit comprises a metal and the second electromagnetic induction units comprise metal coils, the method further comprises: energizing the metal coils.

For example, determining an electrical signal threshold range in which the electrical signals are located; if the electrical signals are within a first electrical signal threshold range, determining that the first touch signals are received; and if the electrical signals are within a second electrical signal threshold range, determining that the second touch signals are received.

At least one embodiment of the present disclosure provides a display device comprising the touch structure.

For example, the display device of claim further comprises a display panel, the display panel comprises an array substrate and a black matrix; wherein an orthographic projection of each of the second electromagnetic induction units arranged in array on the display panel falls within an orthographic projection of the black matrix on the array substrate.

### BRIEF DESCRIPTION OF THE DRAWINGS

Embodiments of the present disclosure will be described in more detail below with reference to accompanying drawings to allow an ordinary skill in the art to more clearly understand embodiments of the present disclosure, in which:

FIG. 1 is a schematically structural diagram of a touch structure provided in an embodiment of the present disclosure;

FIG. 2 is a schematically structural diagram of second electromagnetic induction units in array of the touch structure provided in an embodiment of the present disclosure;

FIG. 3 is a schematically structural diagram of a first electromagnetic induction unit and a second electromagnetic induction unit of the touch structure provided in an embodiment of the present disclosure;

FIG. 4 is a schematically structural diagram of a first electromagnetic induction unit and a second electromagnetic induction unit of the touch structure provided in an embodiment of the present disclosure;

FIG. 5 is a schematically structural diagram of a touch panel provided in an embodiment of the present disclosure;

FIG. 6 is a schematic top view of a display device provided in an embodiment of the present disclosure;

FIG. 7 is a schematic side cross-sectional view of a display device provided in an embodiment of the present disclosure;

FIGS. 8a-8b are schematically structural diagrams of second electromagnetic induction units in array of the touch structure provided in an embodiment of the present disclosure;

FIG. 9 is a flow chart of a method for controlling the touch structure provided in an embodiment of the present disclosure; and

FIG. 10 is a flow chart of an example of determining a type of touch signals by the method for controlling the touch structure provided in an embodiment of the present disclosure.

### DETAILED DESCRIPTION

Technical solutions of the embodiments will be described in a clearly and fully understandable way in connection with the drawings related to the embodiments of the disclosure. It is apparent that the described embodiments are just a part but not all of the embodiments of the disclosure. Based on the described embodiments herein, those skilled in the art can obtain other embodiment(s), without any creative work, which shall be within the scope of the disclosure.

Unless otherwise defined, all the technical and scientific terms used herein have the same meanings as commonly understood by one of ordinary skill in the art to which the present disclosure belongs. The terms, such as “comprise/comprising,” “include/including,” or the like are intended to specify that the elements or the objects stated before these terms encompass the elements or the objects and equivalents thereof listed after these terms, but not preclude other elements or objects. The terms, “on,” “under,” or the like are only used to indicate relative position relationship, and when the position of the object which is described is changed, the relative position relationship may be changed accordingly.

The inventors have noticed that the upper and lower panels of a resistive touch screen need to operate in a loop mode to allow constant conduction of current and the touch screen consumes electricity even without any touch action. When multi-touch is implemented under conventional resistive touch technology, if two points that are touched are too close to each other, the resistance sensor cannot determine whether it is one or two points.

A capacitive touch screen needs to be operated by a finger. Under the capacitive multi-touch technology, the panel must be kept clean, and any stain or even static electricity carried by mist vapor might cause error operation. Further, a capacitive touch-screen tends to experience the so-called “ghost point” in a multi-touch operation, resulting in low accuracy of touch operation.

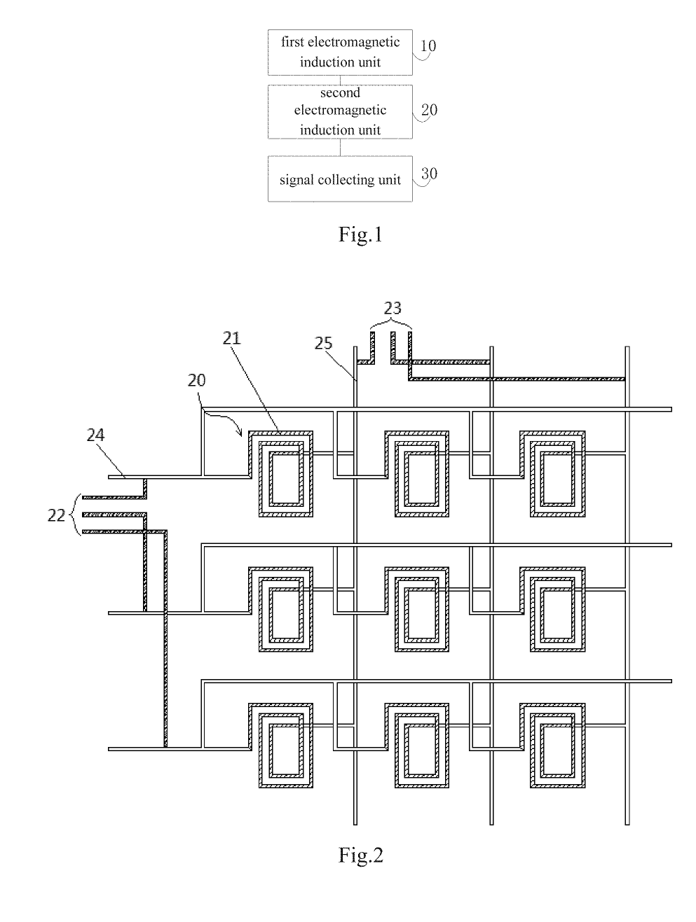

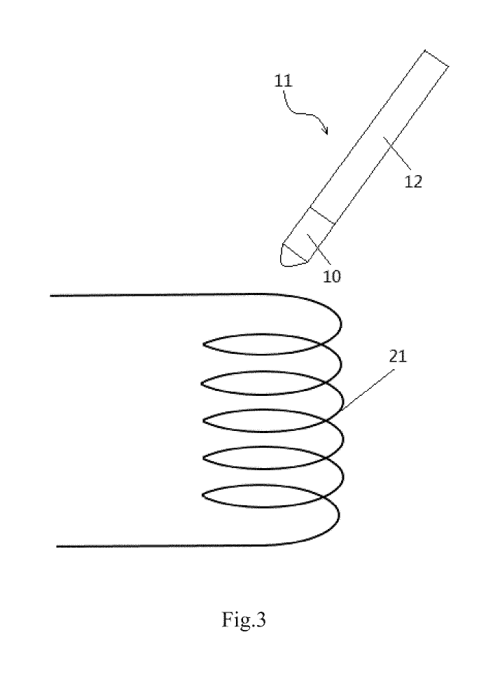

An embodiment of the present disclosure provides a touch structure applying a new touch approach. As shown in FIG. 1 and in combination with FIG. 2. The touch structure includes: a first electromagnetic induction unit 10; second electromagnetic induction units 20 arranged in array which can cooperate with the first electromagnetic induction unit 10 to generate electrical signals by electromagnetic induction; a signal collecting unit 30 for collecting electrical signals generated by electromagnetic induction between the second electromagnetic induction units 10 and the first electromagnetic induction unit 10, so as to determine the position of a second electromagnetic induction unit 20 that generates electromagnetic induction according to the electrical signals, and determining the touch position.

In the touch structure provided in the embodiment of the present disclosure, by disposing second electromagnetic induction units arranged in an array and a first electromagnetic induction unit that can generate electromagnetic induction with the second electromagnetic induction units, while electromagnetic induction is generated between the first electromagnetic induction unit and any of the second electromagnetic induction unit, a signal collecting unit is used to collect respective electrical signals to determine the touch position. The touch structure may be simply implemented, and no external power source is needed for continuously supplying power, because the touch position is determined by collecting electrical signals generated by electromagnetic induction. In this way, the power consumption is reduced. The touch structure is less susceptible to stain and an improved touch accuracy can be obtained.

An embodiment of the present disclosure also provides another example of the touch structure. As shown in FIG. 2, and in combination with FIGS. 1 and 3, the touch structure includes a touch tool or a stylus 11. The touch tool or stylus includes a first electromagnetic induction unit 10 disposed on one end of the stylus 11. For example, as shown in FIG. 3, the first electromagnetic induction unit 10 is a magnet. For example, the magnet can be made of permanent magnet material, or electromagnet material, however, the embodiment of the present disclosure is not limited thereto. For example, the stylus 11 has a body 12 made of insulating material.

The touch structure further includes second electromagnetic induction units 20 arranged in an array. The second electromagnetic induction units 20 can generate electrical signals by electromagnetic induction with the first electromagnetic induction unit 10. For example, as shown in FIGS. 2 and 3, each of the second electromagnetic induction units 20 includes a metal coil 21. Here, the second electromagnetic induction unit 20 including a metal coil 21 refers to the second electromagnetic induction unit 20 may include components other than the metal coil or the second electromagnetic induction unit 20 is mainly implemented by a metal coil 21.

By disposing second electromagnetic induction units 20 including metal coils and a first electromagnetic induction unit 10 applying the magnet, when the magnet of the first electromagnetic induction unit 10 approaches a metal coil 21 of the second electromagnetic induction units 20 (referring to the state shown in FIG. 3), a varying magnetic field is created such that electrical signals are generated in the metal coil 21.

Here, each of the metal coils can be a coil made of copper or silver, however, the embodiment of the present disclosure is not limited thereto.

The touch structure further includes a signal collecting unit 30 electrically connected with a first detection routing 22 and a second detection routing 23 of each of the second electromagnetic induction unit 20, for collecting electrical signals generated by electromagnetic induction between the metal coils 21 of the second electromagnetic induction units 20 and the first electromagnetic induction unit 10, so as to determine the position of the second electromagnetic induction unit 20 (or the metal coil 21) that generates electromagnetic induction according to the electrical signals, and determining the touch position.

In the touch structure provided in the embodiment of the present disclosure, by disposing second electromagnetic induction units arranged in an array and a first electromagnetic induction unit that can generate electromagnetic induction with second electromagnetic induction units, while electromagnetic induction is happened between the first electromagnetic induction unit and the second electromagnetic induction unit, a signal collecting unit is used to collect electrical signals to determine the touch position. The touch structure may be simply implemented and no external power source is needed for continuously supplying power because the touch position is determined by collecting electrical signals generated by electromagnetic induction between the metal coil and the magnet, and power consumption is reduced. The touch structure is less susceptible to stain, resulting in an improved touch accuracy of the touch screen. Further, the touch structure can only implement touch control by a stylus having a magnet, so that a function of preventing mis-touch can be avoided.

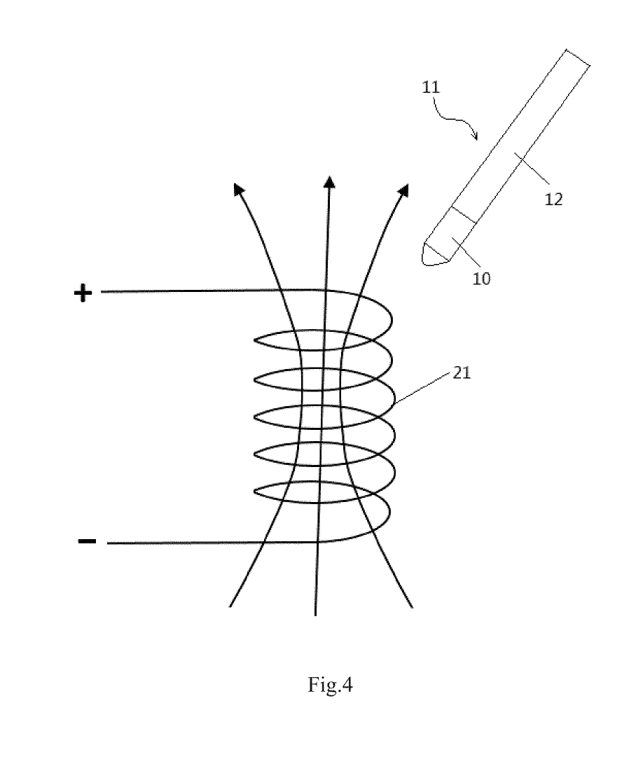

An embodiment of the present disclosure also provides another example of the touch structure. As shown in FIG. 2, and in combination with FIGS. 1 and 4, the touch structure includes a stylus 11 that includes a first electromagnetic induction unit 10 disposed at its one end. For example, as shown in FIG. 4, the first electromagnetic induction unit 10 is made of a magnet. For example, the magnet can be made of permanent magnet material, or electromagnet material, however, the embodiment of the present disclosure is not limited thereto. For example, the stylus 11 has a body 12 made of insulating material.

The touch structure further includes second electromagnetic induction units 20 arranged in an array, which can generate electrical signals by electromagnetic induction with the first electromagnetic induction unit 10. For example, as shown in FIGS. 2 and 4, each of the second electromagnetic induction unit 20 includes a metal coil 21. Here, the second electromagnetic induction unit 20 including a metal coil 21 refers to the second electromagnetic induction unit 20 may include components other than the metal coil or the second electromagnetic induction unit 20 is mainly implemented by the metal coil 21. For example, upon touching, the metal coils may be energized. As shown in FIG. 2, electrical signals inputting may be implemented by the first signal routing 24 and the second signal routing 25.

By providing second electromagnetic induction units 20 including energized metal coils and applying a first electromagnetic induction unit 10 made of a magnet, when the magnet serving as the first electromagnetic induction unit 10 approaches the energized metal coil 21 of the second electromagnetic induction unit 20 (referring to the state shown in FIG. 4), a varying magnetic field is formed such that varying electrical signals are generated in the energized metal coil 21. For example, the energized metal coil 21 generates a magnetic field according to the right-hand rule (in the electrifying way as shown in FIG. 4, the upper end of the metal coil 21 is N pole, and the lower end is S pole), the magnetic field of the magnet would interfere with the original magnetic field of the energized metal coil 21, thereby generating an induced electromotive force to effect the original current value of the metal coil 21.

The touch structure further includes a signal collecting unit 30 electrically connected with a first detection routing 22 and a second detection routing 23 of the second electromagnetic induction unit 20, for collecting electrical signals generated by electromagnetic induction between the energized metal coil 21 of the second electromagnetic induction units 20 and the magnet serving as the first electromagnetic induction unit 10, so as to determine the position of the second electromagnetic induction unit 20 (or the metal coil 21) that generates electromagnetic induction according to the electrical signals, thereby determining the touch position.

In the touch structure provided in the embodiment of the present disclosure, by providing second electromagnetic induction units arranged in an array and a first electromagnetic induction unit that can generate electromagnetic induction with the second electromagnetic induction units, when electromagnetic induction is generated between the first electromagnetic induction unit and any of the second electromagnetic induction units, a signal collecting unit is used to collect respective electrical signals to determine the touch position. The touch structure may be simply implemented and no external power source is needed for continuously supplying power because the touch position is determined by collecting electrical signals generated by electromagnetic induction, power consumption is reduced. The touch structure is less susceptible to stain, resulting in an improved touch accuracy of the touch screen. Furthermore, the metal coil itself has small resistance, its power consumption will be small even it is needed to be energized.

An embodiment of the present disclosure also provides yet another example of the touch structure. As shown in FIG. 2.

As shown in FIG. 2, and in combination with FIGS. 1 and 4, the touch structure includes a stylus 11 that includes a first electromagnetic induction unit 10 disposed at one end. For example, as shown in FIG. 4, the first electromagnetic induction unit 10 is made of metal. For example, the stylus 11 has a body 12 made of insulating material.

The touch structure further includes second electromagnetic induction units 20 arranged in an array, which can generate electrical signals by electromagnetic induction with the first electromagnetic induction unit 10. For example, as shown in FIGS. 2 and 4, the second electromagnetic induction unit 20 includes a metal coil 21. Here, the second electromagnetic induction unit 20 including a metal coil 21 refers to the second electromagnetic induction unit 20 may include components other than the metal coil or the second electromagnetic induction unit 20 is mainly implemented by a metal coil 21. For example, upon touching, the metal coil 21 needs to be energized. As shown in FIG. 2, electrical signals inputting may be implemented by the first signal routing 24 and the second signal routing 25.

By providing second electromagnetic induction units 20 including energized metal coils and applying a first electromagnetic induction unit 10 made of metal, when the metal serving as the first electromagnetic induction unit 10 approaches the energized metal coil 21 of the second electromagnetic induction unit 20 (referring to the state as shown in FIG. 4), a varying magnetic field is created such that varying electrical signals are generated in the energized metal coil 21. For example, the energized metal coil 21 generates a magnetic field according to the right-hand rule (as the electrifying state as shown in FIG. 4, the upper end of the metal coil 21 is N pole, and the lower end is S pole), then, upon approaching the metal coil 21, the metal would interfere with the original magnetic field of the energized metal coil 21, thereby generating an induced electromotive force to effect the original current value of the metal coil 21.

The touch structure further includes a signal collecting unit 30 electrically connected with a first detection routing 22 and a second detection routing 23 of the second electromagnetic induction unit 20, for collecting electrical signals generated by electromagnetic induction between the energized metal coil 21 of the second electromagnetic induction units 20 and the metal serving as the first electromagnetic induction unit 10, so as to determine the position of the second electromagnetic induction unit 20 (or the metal coil 21) that generates electromagnetic induction according to the electrical signals, thereby determining the touch position.

In the touch structure provided in the embodiment of the present disclosure, by providing second electromagnetic induction units arranged in an array and a first electromagnetic induction unit that can generate electromagnetic induction with the second electromagnetic induction units, when electromagnetic induction is generated between the first electromagnetic induction unit and the second electromagnetic induction unit, a signal collecting unit is used to collect electrical signals to thereby determine the touch position. The touch structure may be simply implemented and no external power source is needed for continuously supplying power because the touch position is determined by collecting electrical signals generated by electromagnetic induction, and power consumption is reduced. The touch structure is less susceptible to stain, resulting in an improved touch accuracy of the touch screen. Additionally, the metal coil itself has small resistance, its power consumption is small even when it is energized. Further, the first electromagnetic induction unit 10 made of metal may also implement touch operations, touch tool types which can be used are broadened.

In some optional implementations, the metal coil 11 may be a square coil (referring to FIG. 2), its preparation process is simplified, and production efficiency is improved.

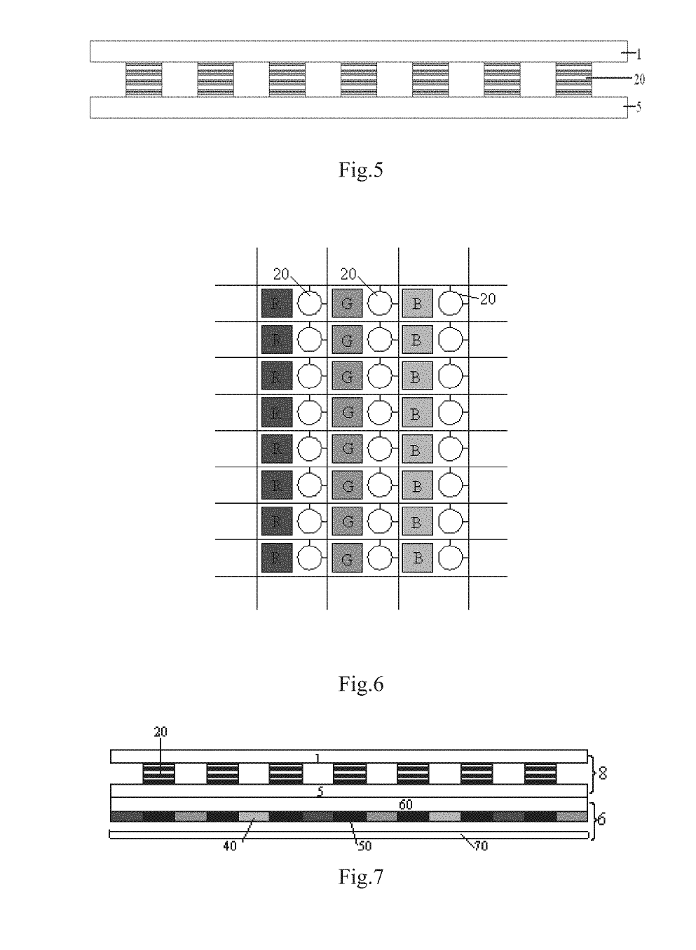

In some optional implementations, the touch structure may further include a first substrate 1 and a second substrate 5, as shown in FIG. 5. For example, as shown in FIG. 7, the touch screen 8 comprises an upper substrate 1 and a lower substrate 5, and second electromagnetic induction units 20 (e.g., metal coils 21) arranged in an array between the upper substrate 1 and the lower substrate 5.

In some optional implementations, the afore-mentioned second electromagnetic induction units 20 arranged in an array may not adopt the connection mode as shown in FIG. 2, that is, metal coils in the same lateral row are connected to the same routing by one end, metal coils in the same vertical column are connected to the same routing by the other end; instead, for example, each of second electromagnetic induction units is provided with a separate routing, that is, not sharing a routing with other electromagnetic induction units, such that electrical signals generated by each second electromagnetic induction unit may be detected separately, thereby realizing precise multi-touch function.

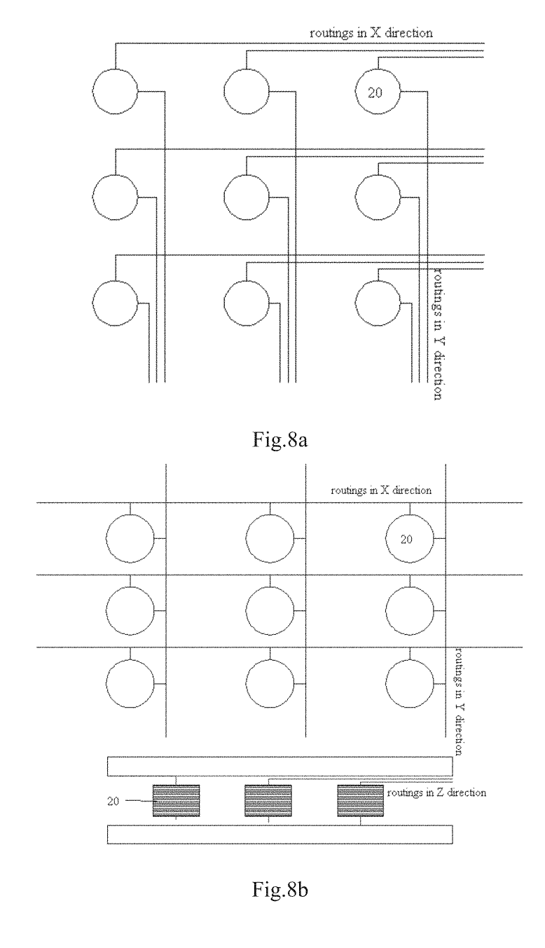

For example, as shown in FIG. 8a, the routings of the second electromagnetic induction units 20 are arranged separately and in parallel in X direction and Y direction to allow the electrical signals created by each of the second electromagnetic induction units can be detected separately, in this way, a precise multi-point-touch can be achieved. For example, as shown in FIG. 8b, the routings of the second electromagnetic induction units 20 are arranged in parallel in Z direction. It is noted that an insulating layer is formed between any two routings in any type of routing arrangements.

It is noted that, in the above-described exemplary embodiments, the first electromagnetic induction unit is implemented by a stylus, however, it can be contemplated that tools for implementing touch are not limited to the stylus in the art. Other than the stylus, it may be other tools that can easily implement the touch operation, for example, a touch glove, or a pair of touch glove. These alternative approaches should not be excluded from the scope of the present disclosure.

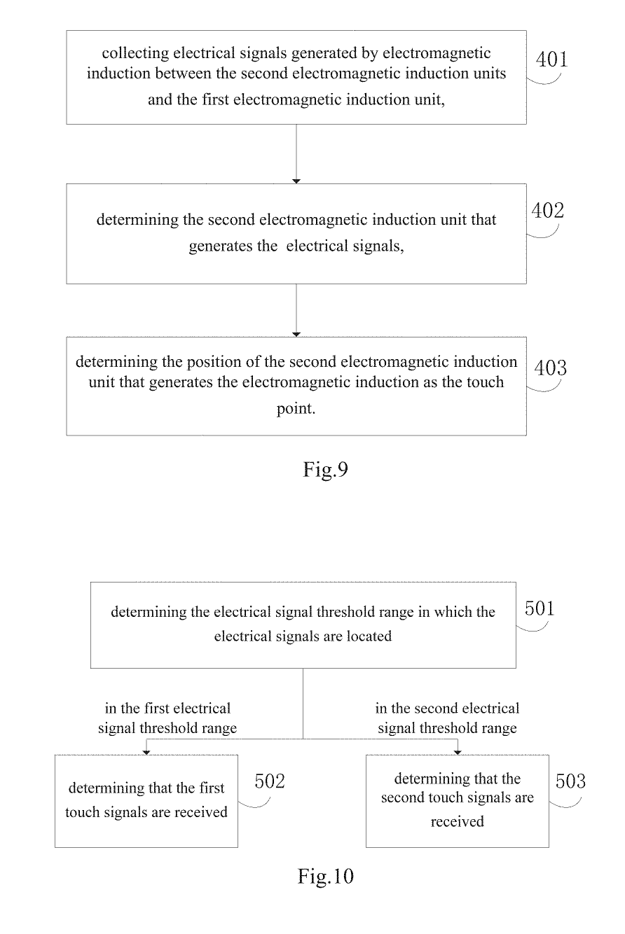

An embodiment of the present disclosure also provides a touch method of a touch structure using a new touch approach. As shown in FIG. 9. The control method of the touch structure may be applied to any of the touch structures and includes the following steps.

In step 401, electrical signals generated by electromagnetic induction between the second electromagnetic induction units and the first electromagnetic induction unit are collected.

In step 402, the second electromagnetic induction unit that generates the electromagnetic induction is determined according to the electrical signals.

In step 403, the position of the second electromagnetic induction unit that generates the electromagnetic induction is determined as the touch point.

In the touch method for the touch structure provided in the embodiment of the present disclosure, by providing second electromagnetic induction units arranged in array and a first electromagnetic induction unit that can generate electromagnetic induction with the second electromagnetic induction units, when electromagnetic induction is generated between the first electromagnetic induction unit and any of the second electromagnetic induction units, a signal collecting unit is used to collect respective electrical signals to determine the touch position. The touch method of the touch structure may be implemented relatively simply. The touch structure is less susceptible to stain, and the touch accuracy of the control method of the touch structure is improved.

In some optional implementations, when the first electromagnetic induction unit 10 is a magnet and the second electromagnetic induction units 20 include metal coils 21, or when the first electromagnetic induction unit 10 includes a metal and the second electromagnetic induction units 20 include metal coils 21, the control method of the touch structure may further include the following steps.

The metal coil is energized such that a relatively accurate touch position may be calculated easily according to the detected electrical signals generated by electromagnetic induction.

In some optional implementations, referring to FIG. 10, the control method of the touch structure further includes the following steps.

In step 501, the electrical signal threshold range of the electrical signals is determined.

In step 502, if the electrical signals are within the first electrical signal threshold range, it is determined that the first touch signals are received.

In step 503, if the electrical signals are within the second electrical signal threshold range, it is determined that the second touch signals are received.

Here, assuming that values of electrical signals in the first electrical signal threshold range are all smaller than the minimum value of electrical signals in the second electrical signal threshold range, touch actions that generate electrical signals in the first electrical signal threshold range are classified as a “light” touch (corresponding to the first touch signals), and touch actions that generate electrical signals in the second electrical signal threshold range are classified as a “heavy” touch (corresponding to the second touch signals), so that a function similar to 3D touch is implemented by differentiating magnitudes of electrical signals.

An embodiment of the present disclosure also provides a display device adopting the new touch way.

The display device comprises a touch screen 8 and a display panel 6. The touch panel 8 comprises the touch structure as described in any of the previous embodiments. The upper substrate of the display panel 6 and the lower substrate 5 of the touch screen 8 may be different substrates, or a same substrate, as shown in FIG. 6.

For example, the display device includes a control unit for processing electrical signals collected by the signal collecting unit 30 to obtain corresponding touch position. For example, the control unit may be integrated in the touch structure or disposed in the display device separately with the touch structure.

In the display device provided in the embodiment of the present disclosure, by providing second electromagnetic induction units arranged in an array and a first electromagnetic induction unit that can generate electromagnetic induction with the second electromagnetic induction units, when electromagnetic induction is generated between the first electromagnetic induction unit and any of the second electromagnetic induction units, a signal collecting unit is used to collect respective electrical signals to determine the touch position. The display device may be simply implemented and no external power source is needed for continuously supplying power because the touch position is determined by collecting electrical signals generated by electromagnetic induction, and the power consumption is reduced. The display device is less susceptible to stain, resulting in improved touch accuracy of the touch display.

In some optional implementations, as shown in FIGS. 6-7, the display device also includes a touch panel 6 in which a black matrix 50 is disposed, the black matrix 50 surrounding sub-pixels 40, such as R, G, B. An orthographic projection of each of the second electromagnetic induction units arranged on the display panel 6 falls within an orthographic projection of the black matrix 50 on the array substrate 70 of the display panel, such that the second electromagnetic induction units themselves will not affect the overall display effect of the display device. For example, the black matrix 50 may refer to the black matrix 50 in the array substrate 70 of the display panel 6 or the black matrix 50 in the color filter substrate 60 of the display panel 6.

It is noted that the display device in the present embodiment may be any product or component having display function, such as electronic paper, a mobile phone, a tablet computer, a TV set, a notebook computer, a digital picture frame or a navigator.

The foregoing is only the exemplary embodiments of the present disclosure, but the scope of the present disclosure is not limited thereto. A person of ordinary skill in the art can make various changes and modifications without departing from the spirit of the present disclosure, and such changes and modifications shall fall into the scope of the present disclosure.

What is claimed is:

1. A touch structure, comprising:
a first electromagnetic induction unit;
second electromagnetic induction units arranged in array, the second electromagnetic induction units being configured to generate electrical signals by electromagnetic inducting with the first electromagnetic induction unit; and
a signal collecting unit configured to collect electrical signals generated by electromagnetic induction between the second electromagnetic induction units and the first electromagnetic induction unit.

2. The touch structure of claim 1, wherein each of the second electromagnetic induction unit comprises a metal coil and the first electromagnetic induction unit comprises a magnet.

3. The touch structure of claim 1, wherein the second electromagnetic induction unit comprises a metal coil and the first electromagnetic induction unit comprises metal.

4. The touch structure of claim 2, wherein the metal coil is a square coil.

5. The touch structure of claim 3, wherein the metal coil is a square coil.

6. The touch structure of claim 1, further comprising a first substrate and a second substrate; the second electromagnetic induction units arranged in array being sandwiched between the first substrate and the second substrate.

7. The touch structure of claim 1, further comprising a stylus, wherein the first electromagnetic induction unit is disposed at an end of the stylus and the stylus includes a body made of insulating material.

8. The touch structure of claim 2, wherein, in the second electromagnetic induction units arranged in array, the metal coils in a same lateral row are connected to a same routing at one end, and the metal coils in a same vertical row are connected to a same routing at another end.

9. The touch structure of claim 3, wherein, in the second electromagnetic induction units arranged in array, the metal coils in a same lateral row are connected to a same routing at one end, and the metal coils in a same vertical row are connected to a same routing at another end.

10. The touch structure of claim 2, wherein, in the second electromagnetic induction units arranged in array, each of the second electromagnetic induction units includes a separate routing, to allow electrical signals generated by each of the second electromagnetic induction units to be detected separately, and to implement multi-touch.

11. The touch structure of claim 3, wherein, in the second electromagnetic induction units arranged in array, each of the second electromagnetic induction units includes a separate routing, to allow electrical signals generated by each of the second electromagnetic induction units to be detected separately, and to implement multi-touch.

12. The touch structure of claim 11, wherein the routings of the second electromagnetic induction units are arranged in parallel, and an insulating layer is disposed between any two routings.

13. A control method for the touch structure of claim 1, comprising:
collecting electrical signals generated by electromagnetic induction between the second electromagnetic induction units and the first electromagnetic induction unit;
determining which one of the second electromagnetic induction units generates the electromagnetic induction according to the electrical signals; and
determining a position of the one second electromagnetic induction unit generating the electromagnetic induction as a touch point.

14. The method of claim 13, wherein,
when the first electromagnetic induction unit comprises a magnet and the second electromagnetic induction units comprise metal coils, the method further comprises:
energizing the metal coils.

15. The method of claim 13, wherein,
when the first electromagnetic induction unit comprises a metal and the second electromagnetic induction units comprise metal coils, the method further comprises:
energizing the metal coils.

16. The method of claim 13, further comprising:
determining an electrical signal threshold range in which the electrical signals are located;
if the electrical signals are within a first electrical signal threshold range, determining that the first touch signals are received; and
if the electrical signals are within a second electrical signal threshold range, determining that the second touch signals are received.

17. A display device comprising the touch structure of claim 1.

18. The display device of claim 17, further comprising a display panel, the display panel comprises an array substrate and a black matrix; wherein an orthographic projection of each of the second electromagnetic induction units arranged in array on the display panel falls within an orthographic projection of the black matrix on the array substrate.
